(19) United States
(12) Patent Application Publication
(10) Pub. No.: US 2021/0224688 A1
(43) Pub. Date: Jul. 22, 2021

(54) METHOD OF TRAINING A MODULE AND METHOD OF PREVENTING CAPTURE OF AN AI MODULE

(71) Applicants: Robert Bosch GmbH, Stuttgart (DE); Robert Bosch Engineering and Business Solutions Private Limited, Bangalore (IN)

(72) Inventors: Manojkumar Somabhai Parmar, Maninagar (IN); Ahmedabad Gujarat, Usmanpura (IN)

(21) Appl. No.: 17/085,299

(22) Filed: Oct. 30, 2020

(30) Foreign Application Priority Data
Jan. 17, 2020 (IN) 202041002113

(51) Int. Cl. G06N 20/00; G06F 21/31

(52) U.S. Cl. CPC G06N 20/00; G06F 21/31

(57) ABSTRACT

A method of training a module in an AI system and a method of preventing capture of an AI module in the AI system. A method of training a module in an AI system, the AI system comprises at least an AI module executing a model, a dataset and the module adapted to be trained. The method comprises the following steps: receiving input data in the AI module, and recording internal behavior of the AI module in response to the input data on the module. The internal behavior of the AI module is recorded in the module.

### CROSS REFERENCE

The present application claims the benefit under 35 U.S.C. § 119 of India Application No. IN 202041002113 filed on Jan. 17, 2020, which is expressly incorporated herein by reference in its entirety.

### FIELD

The present invention relates to a method of training a module in an AI system and a method of preventing capture of an AI module in the AI system.

### BACKGROUND INFORMATION

These days, most of the data processing and decision making systems are implemented using artificial intelligence modules. The artificial intelligence modules use different techniques like machine learning, neural networks, deep learning etc.

Most of the AI based systems receive large amounts of data and process the data to train AI models. Trained AI models generate output based on the use cases requested by the user. Typically the AI systems are used in the fields of computer vision, speech recognition, natural language processing, audio recognition, healthcare, autonomous driving, manufacturing, robotics etc. where they process data to generate required output based on certain rules/intelligence acquired through training.

To process the inputs, the AI systems use various models/algorithms which are trained using the training data. Once the AI system is trained using the training data, the AI systems use the models to analyze the real time data and generate appropriate result. The models may be fine-tuned in real-time based on the results.

The models in the AI systems form the core of the system. Lots of effort, resources (tangible and intangible), and knowledge goes into developing these models.

It is possible that some adversary may try to capture/copy/extract the model from AI systems. The adversary may use different techniques to capture the model from the AI systems. One of the simple techniques used by the adversaries is where the adversary sends different queries to the AI system iteratively, using its own test data. The test data may be designed in a way to extract internal information about the working of the models in the AI system. The adversary uses the generated results to train its own models. By doing these steps iteratively, it is possible to capture the internals of the model and a parallel model can be built using similar logic. This will cause hardships to the original developer of the AI systems. The hardships may be in the form of business disadvantages, loss of confidential information, loss of lead time spent in development, loss of intellectual properties, loss of future revenues etc.

There are conventional methods available to identify such attacks by the adversaries and to protect the models used in the AI system. United States Patent Application Publication US 2019/0095629 A1 describes one such method.

The method described in above U.S. patent application receives the inputs, the input data is processed by applying a trained model to the input data to generate an output vector having values for each of the plurality of pre-defined classes. A query engine modifies the output vector by inserting a query in a function associated with generating the output vector, to thereby generate a modified output vector. The modified output vector is then output. The query engine modifies one or more values to disguise the trained configuration of the trained model logic while maintaining accuracy of classification of the input data.

### BRIEF DESCRIPTION OF THE DRAWINGS

Different modes of the present invention are described in detail in the description and illustrated in the figures.

FIG. 1 illustrates a block diagram representative of the different building blocks of an AI system used for creating a trained module based on unsupervised learning.

FIG. 2 illustrates a block diagram representative of the different building blocks of an AI system used for preventing capture of an AI module in an AI system in accordance with an example embodiment of the present invention.

### DETAILED DESCRIPTION OF EXAMPLE EMBODIMENTS

It is important to understand some aspects of artificial intelligence (AI) technology and artificial intelligence (AI) based systems or artificial intelligence (AI) system. The present invention covers two aspects of AI systems. The first aspect is related to the training of a module in the AI system and second aspect is related to the prevention of capturing of the AI module in an AI system.

Some main aspects of the AI technology and AI systems can be explained as follows. Depending on the architecture of the implements AI system may include may components. One such component is an AI module. An AI module with reference to the present disclosure can be explained as a component which runs an model. A model can be defined as reference or an inference set of data, which is use different forms of correlation matrices. Using these models and the data from these models, correlations can be established between different types of data to arrive at some logical understanding of the data. A person skilled in the art would be aware of the different types of AI models such as linear regression, nïve bayes classifier, support vector machine, neural networks, and the like. It should be understood that the present invention is not specific to the type of AI model being executed in the AI module and can be applied to any AI module irrespective of the AI model being executed. A person skilled in the art will also appreciate that the AI module may be implemented as a set of software instructions, combination of software and hardware or any combination of the same.

Some of the typical tasks performed by AI systems are classification, clustering, regression etc. A majority of classification tasks depend upon labeled datasets; that is, the data sets are labelled manually in order for a neural network to learn the correlation between labels and data. This is known as supervised learning. Some of the typical applications of classifications are: face recognition, object identification, gesture recognition, voice recognition etc. Clustering or grouping is the detection of similarities in the inputs. The cluster learning techniques do not require labels to detect similarities. Learning without labels is called unsupervised learning. Unlabeled data is the majority of data in the world. One law of machine learning is: the more data an algorithm can train on, the more accurate it will be. Therefore, unsupervised learning models/algorithms has the potential to produce accurate models as training dataset size grows.

As mentioned one aspect of the present invention relates to the training of the module in the AI system. The training is an unsupervised learning methodology. The specific details of the unsupervised training methodology will be explained in the later part of this document.

As the AI module forms the core of the AI system, the module needs to be protected against attacks. Attackers attempt to attack the model within the AI module and steal information from the AI module. The attack is initiated through an attack vector. In the computing technology a vector may be defined as a method in which a malicious code/virus data uses to propagate itself such as to infect a computer, a computer system or a computer network. Similarly an attack vector is defined a path or means by which a hacker can gain access to a computer or a network in order to deliver a payload or a malicious outcome. A model stealing attack uses a kind of attack vector that can make a digital twin/replica/copy of an AI module. This attack has been demonstrated in different research papers, where the model was captured/copied/extracted to build a substitute model with similar performance.

The attacker typically generates random queries of the size and shape of the input specifications and starts querying the model with these arbitrary queries. This querying produces input-output pairs for random queries and generates a secondary dataset that is inferred from the pre-trained model. The attacker then take this I/O pairs and trains the new model from scratch using this secondary dataset. This is black box model attack vector where no prior knowledge of original model is required. As the prior information regarding model is available and increasing, attacker moves towards more intelligent attacks. The attacker chooses relevant dataset at his disposal to extract model more efficiently. This is domain intelligence model based attack vector. With these approaches, it is possible to demonstrate model stealing attack across different models and datasets.

As described above, the second aspect of the present invention relates to the prevention of capturing of the AI module in an AI system by detecting the attack. This is correlated to the first aspect of the present invention as the AI module uses a trained model which uses an unsupervised learning methodology to detect the attack and other component of the AI system are used to prevent the attack. The specific details of the unsupervised training methodology will be explained in the later part of this document.

It should be understood that the present invention in particular includes methodology used for training an module in an AI system and a methodology to prevent capturing of an AI module in an AI system. While these methodologies describe only a series of steps to accomplish the objectives, these methodologies are implemented in AI system, which may be a combination of hardware, software and a combination thereof.

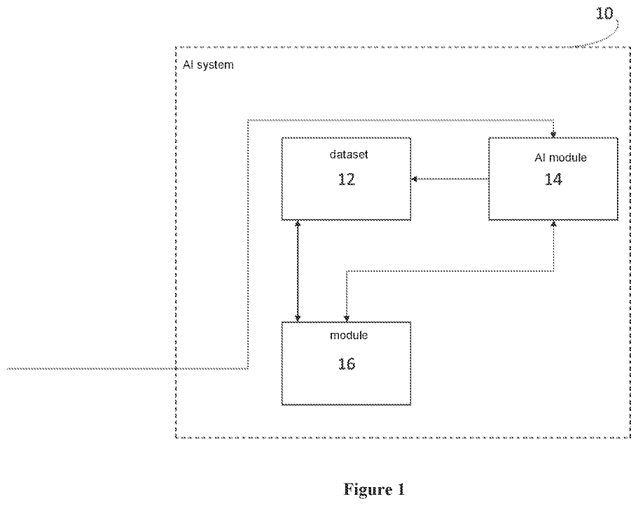

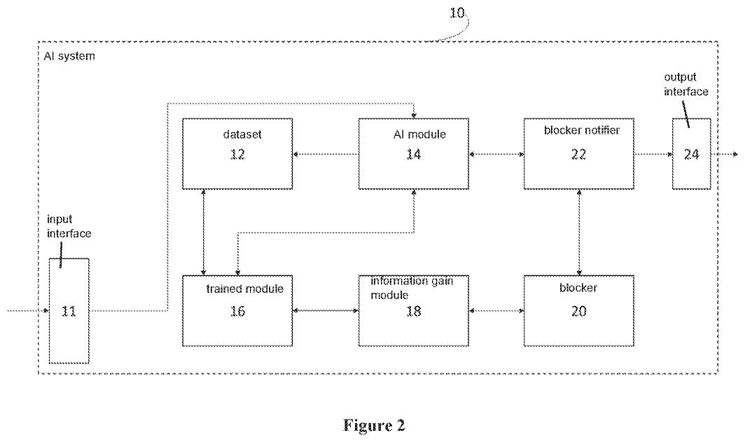

FIG. 1 and FIG. 2 illustrate a block diagrams representative of the different building blocks of an AI system in accordance with the present invention. It should be understood that each of the building blocks of the AI system may be implemented in different architectural frameworks depending on the applications. In one embodiment of the architectural framework all the building block of the AI system are implemented in hardware, i.e., each building block may be hardcoded onto a microprocessor chip. This is particularly possible when the building blocks are physically distributed over a network, where each building block is on individual computer system across the network. In another embodiment of the architectural framework of the AI system are implemented as a combination of hardware and software, i.e., some building blocks are hardcoded onto a microprocessor chip while other building block are implemented in a software which may either reside in a microprocessor chip or on the cloud.

FIG. 1 illustrates a block diagram representative of the different building blocks of an AI system used for creating a trained module based on unsupervised learning. These building blocks are a dataset 12, an AI module 14 and a module 16. The unsupervised training methodology can be explained as follows. A method of training a module 16 in an AI system 10, the AI system 10 comprises at least an AI module 14 executing a model, a dataset 12 and the module 16 adapted to be trained. The method comprises the following steps: receiving input data in the AI module 14, and recording internal behavior of the AI module 14 in response to the input data on the module 16. The internal behavior of the AI module 14 is recorded in the module 16.

The AI module 14 receives input data. The input data is received through an input interface, in the training scenario the input interface is a hardware interface that is connected to the AI module 14 via a wired connection or a wireless connection. In one embodiment the module 16, the dataset 12 and the AI module 14 are implemented as hardware components. The module 16 comprises a processor component, which also has a storage medium. The dataset is a storage medium. The AI module 14 comprises a processor component, which also has a storage medium. As seen in FIG. 1, the input data is received by the AI module 14. The AI module communicates with the dataset 12 and the module 16. The dataset 14 communicates with the module 16. The input data provided to the AI module 14 may be a combination of inputs, which triggers an expected output from the AI module 14. Since the training methodology used here is an unsupervised training methodology, no further labelling of the data is to be done.

Attack vectors are random queries, which are received by the AI module 14. Attack vectors or bad data is random and the number of attack vectors cannot be controlled. The output behavior of the AI module 14 is sent to module 16 and recorded in the module 16. Post recording of the internal behavior of the AI module 14, the module 16 is a trained module 16. The trained module 16 is trained using the unsupervised learning methodology as mentioned in the earlier text. The information from the trained module 16 is also stored in the dataset 24 for further use. Thus, the module 16 is trained in a manner such that the information related to the expected output behavior of the AI module 14 is recorded and is considered as normal behavior of the AI module to an input.

FIG. 2 illustrates a block diagram representative of the different building blocks of an AI system used for preventing capture of an AI module in an AI system in accordance with the present invention. These building blocks are an input interface 11, a dataset 12, an AI module 14, a module 16 (trained module 16), information gain module 18 (IG module), blocker 20, blocker notifier 22 and an output interface 24. As described above, the architectural framework of the AI system depends on the implementing application. The building blocks of the AI system 10 may be implemented in different architectural frameworks depending on the applications. In one embodiment of the architectural framework all the building block of the AI system are implemented in hardware, i.e., each building block may be hardcoded onto a microprocessor chip. This is particularly possible when the building blocks are physically distributed over a network, where each building block is on individual computer system across the network. In another embodiment of the architectural framework of the AI system are implemented as a combination of hardware and software i.e. some building blocks are hardcoded onto a microprocessor chip while other building block are implemented in a software which may either reside in a microprocessor chip or on the cloud. Each building block of the AI system in one embodiment would have a individual processor and a memory.

In accordance with an example embodiment of the present invention, the method to prevent capturing of an AI module 14 in an AI system (10) comprises the following steps: receiving an input from at least one user through an input interface 11, processing the received input in the AI module 14. Flagging the received input based on a trained module 16 (attack vector/unexpected input) in the AI system 10, the flagging executed in the trained module 16; flagging the at least one user from whom the input was received, the flagging executed in the trained module 16; computing information gain extracted by the at least one user based on processing done in the AI module (14), the computing executed in an information gain (IG) module 18 and locking out the at least one user based on the computed information gain, the locking out executed using a blocker 20 and a blocker notifier 22. The information gain is computed using information gain methodology. The method comprises the step of locking out the user if the information gain extracted exceeds a pre-defined threshold. The method comprises the step of locking out the system based on computed information gain extracted by plurality of users. The locking out the system is initiated if the cumulative information gain extracted by plurality of users exceeds a pre-defined threshold. The basic principle of working of this method can be explained as follows. Since an unsupervised training methodology is used to train the module 16, there are no specific labels such as good data or bad data. Any input data that is beyond the expected out of the internal behavior is termed as bad data/attack vector. This can in other words be also called as an anomaly detector, which means that any input/attack vector which does not generate an expected internal behavior from the AI module 14 is flagged as being problematic.

During runtime and during the working of the AI system 10 in accordance with the present invention, the AI system may receive an input through the input interface 11. The input is received by the AI module 14. Irrespective of whether input is good data or bad data (attack vector), the AI module gives a certain output. In the trained module 16 the input received and the user from the whom the input is received is flagged. The information gain for the flagged input is computed in the IG module 18. During computation of the information gain if the information gain exceeds a certain pre-defined threshold then the user is blocked from using and accessing the AI module 10. During the processing of the input data in the trained module 16, if the flagged input data or flagged user is identified by the trained module 16, then this information is passed onto the blocker 20 through the information gain module. The blocker then blocks this flagged data or flagged user.

In certain cases, it is also possible that there may be plurality of user sending bad data or attack vectors. In this case, the information gain extracted by one single user would not be alarming to block the user. In this case, the cumulative information gain is computed by the IG module 18 and the blocker 20 blocks out the entire AI system. If the information gain extracted during a single instance of inputting bad data or attack vector is less than pre-defined threshold then the AI module 14 will provide some output through the output interface 24. Similarly, if the input data is a good data, then the AI module 14 will provide the expected output through the output interface 24.

As described above, the trained module 16 is adapted to flag user. Flagging of the user would be based on the user profile. The following information may be used to store information regarding the user: types of the bad data/attack vectors provided by the user, number of times the user input bad data/attack vector, the time of the day when bad data/attack vector was inputted to the AI system, the physical location of the user, the digital location of user, the demographic information of the user and the like. In addition the user profile may be used to determine whether the user is habitual attacker or was it one time attack or was it only incidental attack etc. Depending upon the user profile, the steps for unlocking of the system may be determined. If it was first time attacker, the user may be locked out temporarily. If the attacker is habitual attacker then a stricter locking steps may be suggested.

As mentioned earlier, based on the cumulative information gain extracted, there is a possibility to lock out the AI system 10 as well. Once the system is locked, there is also a mechanism and criteria to unlock the AI system. The AI system 10 may be unlocked only after an unlocking criteria is met. The unlocking criteria may be a certain event, for example, a fixed duration of time, a fixed number of right inputs, a manual override etc.

It should be understood that the AI system as described herein through the representation shown in FIG. 1 and FIG. 2 are only illustrative and do not limit the scope of the invention from the perspective of the location of the various building blocks of the AI system 10. It is envisaged the position of the building blocks of the AI system can be changed and these are within the scope of the present invention. The implementation of the each of the building blocks of the AI system 10 can be done in any form which may be hardware, software or a combination of hardware and software.

What is claimed is:

1. A method of training a module in an AI system, the AI system including at least an AI module executing a model, a dataset, and the module adapted to be trained, the method comprising the following steps:
receiving input data in the AI module; and
recording internal behavior of the AI module in response to the input data in the AI module.

2. The method as recited in claim 1, wherein the internal behavior of the AI module is recorded in the module.

3. The method as recited in claim 2, wherein the module, post recording of the internal behavior of the AI module, is a trained module.

4. The method as recited in claim 3, wherein the trained module is trained using a unsupervised learning methodology.

5. A method to prevent capturing of an AI module in an AI system, the method comprising the following steps:
receiving an input from at least one user through an input interface;
processing the received input in the AI module;
flagging the received input based on a trained module in the AI system, the flagging being executed in the trained module;
flagging the at least user from whom said input was received, the flagging executed in the trained module;
computing information gain extracted by the at least one user based on processing done in the AI module, the computing being executed in an information gain module; and
locking out the at least one user based on the computed information gain, the locking out executed using a blocker and a blocker notifier.

6. The method as recited in claim 5, wherein the information gain is computed using information gain methodology.

7. The method as recited in claim 5, wherein the step of locking out of the at least one user is performed when the information gain extracted exceeds a pre-defined threshold.

8. The method as recited in claim 5, wherein the locking out of the at least one user is based on the computed information gain extracted by a plurality of users.

9. The method as recited in claim 8, wherein locking out of the at least one user is initiated when the cumulative information gain extracted by the plurality of users exceeds a pre-defined threshold.
